(19) United States
(12) Patent Application Publication
(10) Pub. No.: US 2023/0226811 A1
(43) Pub. Date: Jul. 20, 2023

(54) ADHESION METHOD FOR ADHERING GLASS COMPONENT AND RESIN COMPONENT

(71) Applicant: Panasonic Intellectual Property Management Co., Ltd., Osaka (JP)

(72) Inventor: Masaya MOCHIZUKI, Kanagawa (JP)

(73) Assignee: Panasonic Intellectual Property Management Co., Ltd., Osaka (JP)

(21) Appl. No.: 18/099,010

(22) Filed: Jan. 19, 2023

(30) Foreign Application Priority Data
Jan. 20, 2022 (JP) 2022-006911

(51) Int. Cl. B32B 37/12; B32B 17/10; B32B 7/14; B32B 27/30; B32B 37/18

(52) U.S. Cl. CPC B32B 37/12; B32B 17/10; B32B 7/14; B32B 27/308; B32B 37/182; B32B 2310/0843; B32B 2315/08; B32B 2255/26; B32B 2333/04; B32B 2457/20

(57) ABSTRACT

A glass component, which has a first surface and a second surface that faces in a direction opposite to the first surface, and a resin component are adhered. The first surface of the glass component and the resin component are caused to face each other and the glass component and the resin component are layered, the first surface of the glass component being provided with an acrylic ink printing. IR laser is radiated from the first surface of the glass component toward the printing, and the glass component and the resin component are welded by a heat of dissolution of the printing.

### BACKGROUND

### 1. Field

The present disclosure relates to adhesion technology and, more particularly, to an adhesion method for adhering a glass component and a resin component.

### 2. Description of the Related Art

The steps to manufacture a display involves various thermal processes. One of the processes is a process to adhering the front glass substrate and the rear glass substrate in an airtight manner. For example, a thin film that absorbs laser light is sandwiched between glass members to adhere the members. The thin film is irradiated by a laser light via a glass plate. This causes the two glass members sandwiching the thin film to be welded by the heat generated by the thin film (see, for example, patent literature 1).

[Patent literature 1] JP2000-26127

The steps to manufacture a display involves a process to adhere a glass component and a resin component. For adhesion of a glass component and a resin component, adhesion by an adhesive agent for adhesion via a double-sided tape or an adhesive is widely used in the related art. However, the adhesion strength of adhesion by an adhesive agent is relatively small so that the adhesion area should be extended in order to increase the adhesion strength.

### SUMMARY

The present disclosure addresses the issue described above, and a purpose thereof is to provide a technology for increasing the strength of adhesion between a glass component and a resin component.

An adhesion method according to an embodiment of the present disclosure is an adhesion method adapted to adhere a glass component, which has a first surface and a second surface that faces in a direction opposite to the first surface, and a resin component, the method including: causing the first surface of the glass component and the resin component to face each other and layering the glass component and the resin component, the first surface of the glass component being provided with an acrylic ink printing;

and radiating laser light from the second surface of the glass component toward the printing and welding the glass component and the resin component by a heat of dissolution of the printing.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 is a cross-sectional view showing the structure of a display according to a comparative example of the embodiment;

FIG. 2 is a cross-sectional view showing a step of manufacturing the display according to the embodiment;

FIG. 3A-3D are partial cross-sectional view showing steps of manufacturing the display following the step of FIG. 2;

FIG. 4 is a cross-sectional view showing the structure of the display according to the embodiment;

FIGS. 5A-5B show the structure of a sample used in the embodiment; and

FIG. 6 shows the results of experiment on the sample of FIG. 5.

### DETAILED DESCRIPTION

The invention will now be described by reference to the preferred embodiments. This does not intend to limit the scope of the present invention, but to exemplify the invention.

Before describing the embodiment of the present disclosure in specific details, a summary of the embodiment will be described. The embodiment relates to an adhesion method for adhering a cover glass (glass component) and a case (resin component) in the steps to manufacture a display mounted on a vehicle. As described above, a glass component and a resin component are adhered by a double-sided tape or an adhesive agent in the related art, but the adhesion strength of adhesion by a double-sided tape, etc. is relatively small. Thus, an increase in adhesion strength necessitates an increase in adhesion area. Further, the related-art approach has disadvantages in that a double-sided tape need be sticked or an adhesive agent need be applied and so the adhesion steps are time-consuming and in that the number of components is increased because a double-sided tape or an adhesive agent is necessary other than the glass component and the resin component.

To increase the strength of adhesion of a glass component and a resin member, the glass component and the resin member are welded by laser welding via an ink according to the embodiment. If a condition to weld two glass members by laser welding is used, however, the temperature of the resin member will be so high that the resin member will be completely dissolved. If the component and the member are irradiated by laser insufficiently to prevent dissolving of the resin member, sufficient adhesion strength cannot be obtained. In this background, an acrylic ink is used in the embodiment.

The terms “parallel” and “orthogonal” in the following description not only encompass completely parallel or orthogonal but also encompass slightly off-parallel and slightly non-orthogonal within the margin of error. The term “substantially” means identical within certain limits.

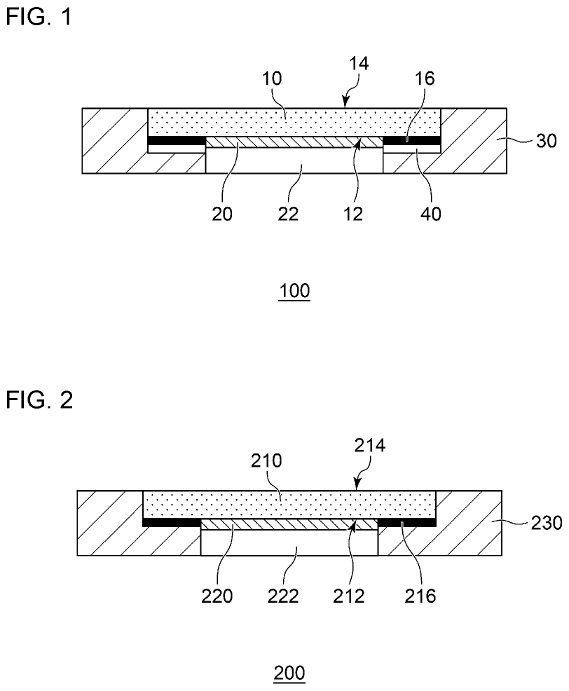

A description will first be given of the structure of a display 100 according to the related art in which a double-sided tape is used. FIG. 1 is a cross-sectional view showing the structure of the display 100 according to a comparative example. The display 100 includes a glass component 10, a liquid crystal component 20, a backlight 22, a resin component 30, and a double-sided tape 40. A user is located above the display 100 of FIG. 1, and the user is viewing a video displayed on the display 100 from above. A device on which the display 100 is mounted is provided beneath the display 100 of FIG. 1, and the device outputs a video signal to the display 100. Therefore, denoting the side above the display 100 as “user side”, the side beneath the display 100 is denoted by “intra-device side”.

The glass component 10 is a glass cover and is referred to as a glass plate. The surface of the glass component 10 on the intra-device side is a first surface 12, and the surface of the glass component 10 on the user side is a second surface 14. The first surface 12 and the second surface 14 face in directions opposite to each other. When the glass component 10 is viewed from the user side, the glass component 10 has a rectangular shape, and a frame-shaped printing 16 is provided at the outer edge of the first surface 12. The printing 16 has, for example, a black color.

A liquid crystal component 20 is provided in the central part of the first surface 12 of the glass component 10 that is not provided with the printing 16. The liquid crystal component 20 includes a color filter, a liquid crystal, a transparent electrode, etc. The backlight 22 is provided on the intra-device side of the liquid crystal component 20. By causing the backlight 22 to radiate a light from the intra-device side while a video is being displayed on the liquid crystal component 20, the screen is lighted.

The resin component 30 has an opening in the central part of the surface on the user side, and the opening extends through the intra-device side to form a through hole. The glass component 10 can be mounted on the opening of the resin component 30 from the user side. Further, the liquid crystal component 20 and the backlight 22 are provided in the through hole. A double-sided tape 40 is sticked on the intra-device side of the printing 16 on the first surface 12 of the glass component 10. Like the printing 16, the double-sided tape 40 may have a frame shape. The intra-device side of the double-sided tape 40 is sticked to the resin component 30. Consequently, the glass component 10 and the resin component 30 are adhered by the double-sided tape 40.

Hereinafter, the adhesion method according to the embodiment is described in the sequence (1) layering step, (2) laser irradiation step. (1) Layering step

FIG. 2 is a cross-sectional view showing a step of manufacturing the display 200. The display 200 includes a glass component 210, a liquid crystal component 220, a backlight 222, and a resin component 230. The display 200, the glass component 210, the liquid crystal component 220, the backlight 222, and the resin component 230 correspond to the display 100, the glass component 10, the liquid crystal component 20, the backlight 22, and the resin component 30 of

FIG. 1, respectively. Denoting the side above the display 200 of FIG. 2 as “user side”, the side beneath the display 200 is denoted by “intra-device side”.

The surface of the glass component 210 on the intra-device side is a first surface 212, and the surface of the glass component 210 on the user side is a second surface 214. The first surface 212 and the second surface 214 face in directions opposite to each other. The glass component 210 is has a property to transmit laser light. For example, 940 nm semiconductor laser is the light source of laser light.

When the glass component 210 is viewed from the user side, the glass component 210 has a rectangular shape, and a frame-shaped printing 216 is provided at the outer edge of the first surface 212. The printing 216 is formed by a substance that absorbs laser light, and, for example, an acrylic ink. For example, the thickness of the printing 216 is less than 30 μm. The thickness of the printing 216 may be 5 μm or greater. The printing 16 has, for example, a black color.

A liquid crystal component 220 is provided in the central part of the first surface 212 of the glass component 210 that is not provided with the printing 216. The backlight 222 is provided on the intra-device side of the liquid crystal component 220. The resin component 230 has an opening in the central part of the surface on the user side, and the opening extends through the intra-device sided to form a through hole. The glass component 210 can be mounted on the opening of the resin component 230 from the user side. Further, the liquid crystal component 220 and the backlight 222 are provided in the through hole. The resin component 230 includes, for example, an acrylic resin, and the acrylic resin is a material of the same type as the acrylic ink. The first surface 212 of the glass component 210 and the resin component 230 are caused to face each other so as to layer the glass component 210 and the resin component 230.

(2) Laser irradiation step

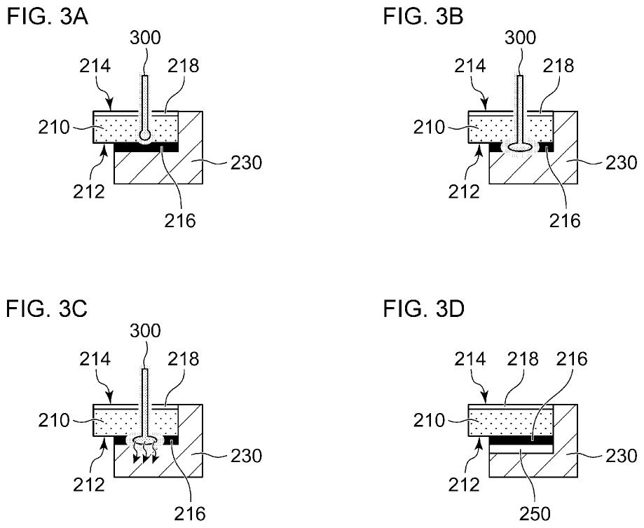

FIG. 3A-3D are partial cross-sectional views showing steps of manufacturing the display 200. FIGS. 3A-3D show a part of FIG. 2 on an enlarged scale. A glass coating 218 is provided on the second surface 214 of the glass component 210. The glass coating 218 also has a property to transmit laser light. As shown in FIG. 3A, an infrared (IR) laser 300 is radiated from the second surface 214 of the glass component 210 toward the printing 216. The IR laser 300 is transmitted through the glass coating 218 and the glass component 210.

FIG. 3B shows a state that follows the state of FIG. 3A. The IR laser 300 is transmitted through the glass component 210 and reaches the printing 216. As a result, the printing 216 is irradiated by the IR laser 300. FIG. 3C shows a state that follows the state of FIG. 3B. The printing 216 generates heat and is dissolved by the irradiation by the IR laser 300. The heat of dissolution generated by the printing 216 dissolves the part of the resin component 230 near the printing 216. FIG. 3D shows a state that follows the state of FIG. 3C. By cooling the part of the resin component 230 near the printing 216 after it is dissolved, that part forms the welding part 250 by being solidified. The welding part 250 welds the glass component 210 and the resin component 230.

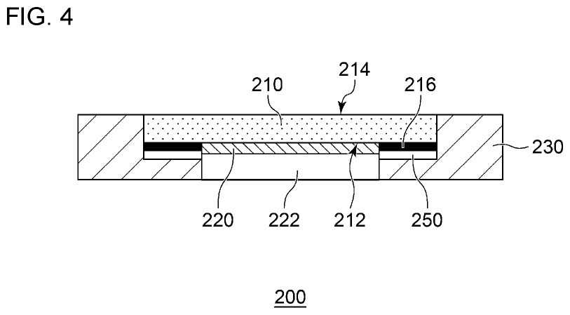

FIG. 4 is a cross-sectional view showing the structure of the display 200. FIG. 4 shows the entirety of the structure shown in FIG. 3D. FIG. 4 shows a structure as similarly shown in FIG. 2 but shows that the welding part 250 is provided between the glass component 210 and the resin component 230, and the welding part 250 welds the glass component 210 and the resin component 230.

### (Embodiment)

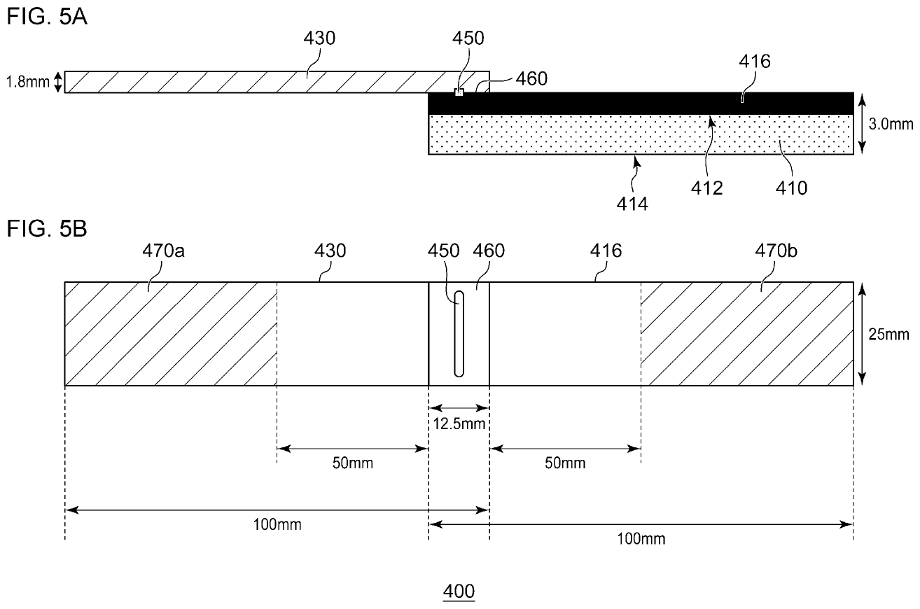

We have conducted an experiment to determine the type of ink used in the printing 216 and the thickness of the printing 216. FIGS. 5A-5B show the structure of a sample 400 used in the embodiment. FIG. 5A is a side view of the sample 400, and FIG. 5B is a top view of the sample 400. A printing 416 is provided on a first surface 416 of a glass component 410. The combination of the glass component 410 and the printing 316 is configured to have a length of 100 mm, a width of 25 mm, and a thickness of 3.0 mm. The resin component 430 is configured to have, for example, a length of 100 mm, a width of 25 mm, and a thickness of 1.8 mm. The combination of the glass component 410 and the printing 416 with the resin component 430 arranged such that the parts of 12.5 m in the lengthwise direction are layered. The parts that are layered are shown as layered parts 460. By welding the glass component 410 and the resin component 430 by the IR laser 300 (not shown) in this state, the welding part 450 is formed. The part of the resin component 430 opposite to the layered parts 460 is a first grip part 470a, and the part of the combination of the glass component 410 and the printing 416 opposite to the layered parts 460 is a second grip part 470b.

The glass component 410 is manufactured from a soda-lime blue sheet glass, and the resin component 430 is manufactured from a PCABS test piece. The PCABS test piece is an acrylic resin. In the experiment, a urethane based ink and an acrylic ink are used to form the printing 416. The urethane based ink is 1st:HF GV3 RX01 710Black/2nd:HF SG460 NSY1312T-2Black (from Seiko Advance), and the acrylic ink is IRX-HF Sumi (from Teikoku Printing Inks). Further, the urethane based ink is a material different in nature from the material of the resin component 430, and the acrylic ink is a material similar in nature to the material of the resin component 430. In the experiment, the thickness of the printing 416 is varied between 5 μm, 10 μm, and 30 μm. The output of the IR laser used in welding is configured to be 15 W, the spot diameter to be φ3 (mm), the laser irradiation speed to be 10 (mm/sec), 15 (mm/sec), and 20 (mm/sec).

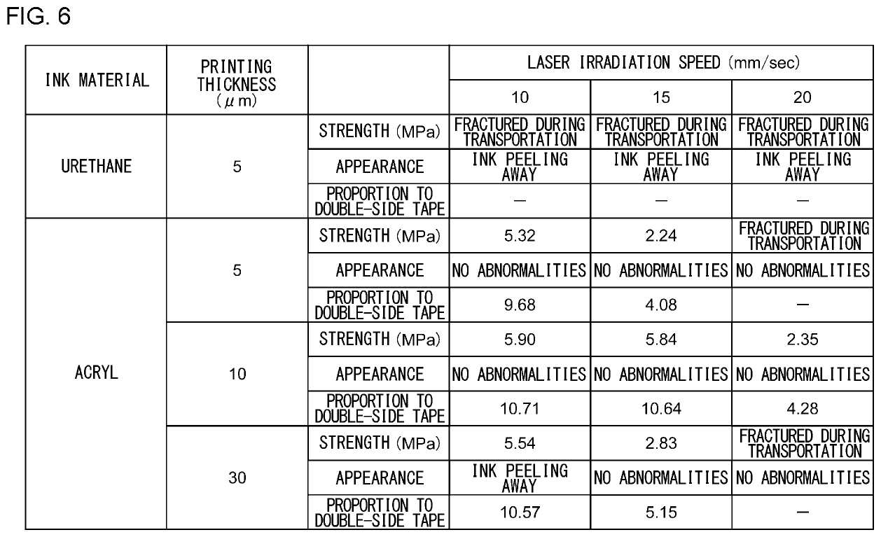

FIG. 6 shows the results of experiment on the sample 400. The table shows the strength (MPa) and appearance that result from the experiment using the sample 400. FIG. 6 also shows the comparative results obtained when the glass component 410 and the resin component 430 are adhered by using a double-sided tape (from 3M). The strength was measured by pulling the first grip part 470a and the second grip part 470b by a universal tester Autograph AG-X20kNX (from Shimadzu). The appearance was visually inspected. The use of the urethane based ink resulted in the strength of a level that fractures the assembly during transportation and the appearance showing the ink peeling away.

The use of the acrylic ink resulted in the strength of a level that fractures the assembly during transportation when the thickness is configured to be 5 μm and the laser irradiation speed to be 20 (mm/sec) and when the thickness is configured to be 30 μm and the laser irradiation speed to be 20 (mm/sec). In the other conditions, however, the strength is increased as compared with the case of adhesion by a double-sided tape. Further, the thickness of 30 μm and the laser irradiation speed of 10 (mm/sec) resulted in the appearance showing the ink peeling away. In the other conditions, however, no abnormalities were found in the appearance. By increasing the thickness of the acrylic ink from 5 μm, the amount of acrylic ink increases so that the strength (MPa) increases. When the thickness of the acrylic ink reaches 30 μm, on the other hand, the printing 416 is not dissolved by the IR laser 300 sufficiently so that the strength (MPa) decreases.

Based on the above, the acrylic ink is more suitable for the printing 416 than the urethane based ink. In particular, the acrylic ink thickness of the acrylic ink of less 30 μm and 5 μm or greater is suitable. It should be noted that the printing thickness of less than 5 μm is not favorable because it is difficult to ensure a uniform post-coating thickness.

According to the embodiment, the glass component printed with an acrylic ink and the resin component are adhered by laser irradiation so that the strength of adhesion of the glass component and the resin component is increased. Further, the strength of adhesion is increased so that the adhesion area can be decreased. Further, the adhesion area is decreased so that a thin bezel display can be realized and the flexibility of design is increased. Further, the resin component and the printing are made of similar materials so that the strength of adhesion of the glass component and the resin component is increased. Further, the thickness of the printing is configured to be less than 30 μm so that the printing can be dissolved sufficiently. Further, the thickness of the printing is configured to be 5 μm or greater so that the shortage of the acrylic ink is avoided.

One embodiment of the present disclosure is summarized below. An adhesion method of an embodiment of the present disclosure is an adhesion method adapted to adhere a glass component, which has a first surface and a second surface that faces in a direction opposite to the first surface, and a resin component, the method including: causing the first surface of the glass component and the resin component to face each other and layering the glass component and the resin component, the first surface of the glass component being provided with an acrylic ink printing; and radiating laser light from the second surface of the glass component toward the printing and welding the glass component and the resin component by a heat of dissolution of the printing.

According to the embodiment, the glass component printed with an acrylic ink and the resin component are adhered by laser irradiation so that the strength of adhesion of the glass component and the resin component is increased.

The resin component may include an acrylic resin.

In this case, the resin component and the printing are made of similar materials so that the strength of adhesion of the glass component and the resin component is increased.

A thickness of the printing provided on the first surface of the glass component in the layering step may be less than 30 μm. In this case, the printing can be dissolved sufficiently since the thickness of the printing is configured to be less than 30 μm.

A thickness of the printing provided on the first surface of the glass component in the layering step may be 5 μm or greater. Further, the thickness of the printing is configured to be 5 μm or greater so that the shortage of the acrylic ink is avoided.

Described above is an explanation of the present disclosure based on the embodiment. The embodiment is intended to be illustrative only and it will be understood by those skilled in the art that various modifications to constituting elements and processes could be developed and that such modifications are also within the scope of the present disclosure.

According to the adhesion method of the embodiment, a cover glass (glass component) and a case (resin component) are adhered. Alternatively, however, the adhesion method of the embodiment may be used to adhere a glass component other than a cover glass and a resin component other than a case. According to this variation, the scope of application of the embodiment is extended.

While various embodiments have been described herein above, it is to be appreciated that various changes in form and detail may be made without departing from the spirit and scope of the invention(s) presently or hereafter claimed.

### CROSS-REFERENCE TO RELATED APPLICATION

This application is based upon and claims the benefit of priority from the prior Japanese Patent Application No. 2022-6911, filed on Jan. 20, 2022, the entire contents of which are incorporated herein by reference.

What is claimed is:

1. An adhesion method adapted to adhere a glass component, which has a first surface and a second surface that faces in a direction opposite to the first surface, and a resin component, the method comprising:
causing the first surface of the glass component and the resin component to face each other and layering the glass component and the resin component, the first surface of the glass component being provided with an acrylic ink printing; and
radiating laser light from the second surface of the glass component toward the printing and welding the glass component and the resin component by a heat of dissolution of the printing.

2. The adhesion method according to claim 1, wherein the resin component includes an acrylic resin.

3. The adhesion method according to claim 1, wherein a thickness of the printing provided on the first surface of the glass component in the layering is less than 30 μm.

4. The adhesion method according to claim 2, wherein a thickness of the printing provided on the first surface of the glass component in the layering is less than 30 μm.

5. The adhesion method according to claim 1, wherein a thickness of the printing provided on the first surface of the glass component in the layering is 5 μm or greater.

6. The adhesion method according to claim 2, wherein a thickness of the printing provided on the first surface of the glass component in the layering is 5 μm or greater.

7. The adhesion method according to claim 3, wherein a thickness of the printing provided on the first surface of the glass component in the layering is 5 μm or greater.

8. The adhesion method according to claim 4, wherein a thickness of the printing provided on the first surface of the glass component in the layering is 5 μm or greater.
